(19) United States
(12) Patent Application Publication
(10) Pub. No.: US 2024/0066535 A1
(43) Pub. Date: Feb. 29, 2024

(54) CONTROLLABLY PROVIDING A COATING OF NANOPARTICLES ON A CONVEYED SUBSTRATE

(71) Applicant: Spraying Systems Co., Wheaton, IL (US)

(72) Inventors: Chad Mathew Foster Sipperley, Palm City, FL (US); Justin Alan Burger, Fulshear, TX (US); Rudolf J. Schick, Forest Park, IL (US)

(21) Appl. No.: 18/237,687

(22) Filed: Aug. 24, 2023

Related U.S. Application Data
(60) Provisional application No. 63/400,485, filed on Aug. 24, 2022.

(51) Int. Cl. B05B 5/00; B05B 5/025

(52) U.S. Cl. CPC B05B 5/001; B05B 5/025

(57) ABSTRACT

A spray system and method are described for controllably applying a coating of nanoparticles to a substrate. In particular, spray system arrangements are described that are configured to meet the goals of high quality nanoparticle deposition on a substrate with minimal waste of costly nanoparticle material. More particularly, a nanoparticle spray system is described herein that includes: a spray nozzle configured to emit a nanoparticle-laden spray flow; a conveyed substrate configured to be conveyed at a velocity; and a controller configured to operate in a feedback loop such that nanoparticles of the nanoparticle-laden spray flow are controllably deposited on a surface of the conveyed substrate.

### CROSS-REFERENCE TO RELATED APPLICATIONS

This application is a non-provisional of U.S. Provisional Patent Application No. 63/400,485, filed on Aug. 24, 2022, entitled “CONTROLLABLY PROVIDING A COATING OF NANOPARTICLES ON A CONVEYED SUBSTRATE,” the contents of which are hereby incorporated by reference in their entirety.

### TECHNICAL FIELD

The present invention relates generally to spray-coating ultra-fine particles on a surface, and more particularly, to systems for depositing nanoparticles on a substrate.

### BACKGROUND

The deposition of ultrafine particles on a substrate to form a coating presents an abundance of technological challenges arising from the physical properties of such particles, as well as a need to ensure minimal waste—as such particulate matter is extremely expensive. Ultrafine (nano) particles may be deposited, and thereby form a coating, on a substrate by use of wet spraying or dry spraying such particulate matter. In a wet spray arrangement, the nanoparticles are carried by a solvent liquid that evaporates either before or after the particles reach the substrate. In a dry spray arrangement, a gas flow passes through a fluidized bed of nanoparticles distributing the nanoparticles in space before they reach the substrate.

In both wet and dry arrangements, the fluid dynamics/physics of the system are often contrary to a goal of achieving high deposition rates. In particular, small droplets carrying nanoparticles or the particles themselves have low inertia and follow the gas-phase flow field quite well. Since the substrate represents at least a partial blockage to the flow, the streamlines of the gas phase tend to drive the nanoparticles around the surface rather than onto it. The droplets following these streamlines will then not deposit on the target substrate, thus decreasing transfer efficiency of the nanomaterial.

For purposes of the current disclosure, the following terminology will be used.

Substrate: a solid or partially-solid surface (such as a woven material) that is the target for deposition.

Spray system: a fluid mechanical system where a fluid is atomized such that a bulk fluid is broken into smaller particles and distributed in space. The fluid being atomized may be a liquid, a suspension or amalgam of particles in a liquid, or a fluidized bed of particles. The spray process may be driven by the fluid mechanic effects of a single fluid or the result of two or more fluids (fluidized beds, liquids, or gases) acting in concert to break the bulk fluid into smaller particles.

Particle: droplets, microscopic solids, nanoparticles (in a liquid, free-flying, or adhered to the substrate), and clusters of nanoparticles.

Fluid: A liquid, a gas, or a fluidized bed of solid particles held in a fluidized state by a liquid or a gas.

Bulk fluid: The environment into which the spray is introduced.

Spray flow: Sprays do not generally enter the bulk fluid with zero relative velocity. As such, drag forces between the fluid(s) in the spray will tend to interact with the bulk fluid to equalize velocities. The modified bulk fluid flow is referred to as the “induced” flow and the resultant velocity as the induced velocity to differentiate it from the bulk flow in the absence of the spray. Together the induced bulk flow and fluid motion from the spray fluids constitute the spray flow.

Users of such systems have a strong interest in ensuring that a particular nanoparticle spraying application will provide, with minimal waste (i.e., with high deposition rate) a particular desired coverage—e.g., both complete coverage and even distribution of a particular desired amount.

### BRIEF SUMMARY OF THE INVENTION

Embodiments of the present invention provide spray system arrangements configured to meet the above-identified goals of high quality nanoparticle deposition on a substrate with minimal waste of costly nanoparticle material. More particularly, a nanoparticle spray system is described herein that includes: a spray nozzle configured to emit a nanoparticle-laden spray flow; a conveyed substrate configured to be conveyed at a velocity; and a controller configured to operate in a feedback loop such that nanoparticles of the nanoparticle-laden spray flow are controllably deposited on a surface of the conveyed substrate.

Additionally a method is described herein for applying a coating of nanoparticles, using a nanoparticle spray system, to a substrate. The method includes: emitting, using a spray nozzle, a nanoparticle-laden spray flow; conveying a conveyed substrate at a velocity; and controlling the nanoparticle spray system, by a controller, to operate in a feedback loop such that nanoparticles of the nanoparticle-laden spray flow are controllably deposited on a surface of the conveyed substrate.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is an exemplary schematic block diagram depicting a nanoparticle spray system arrangement wherein output is emitted from a spray nozzle at an oblique angle with respect to substrate surface in accordance with the present disclosure;

FIG. 2 is an exemplary schematic block diagram depicting a spray system that is further configured to effectively match nanoparticle velocity and substrate surface velocity within a deposition region of a moving substrate in accordance with the present disclosure;

FIG. 3 is another exemplary schematic block diagram where an air knife is added to any of the other implementations provided herein in accordance with the present disclosure;

FIG. 4 is an exemplary modification of the illustrative example of FIG. 3, wherein the air knife is configured so that the air knife output has a flow velocity component parallel, and in a direction of motion of the substrate in accordance with the present disclosure;

FIG. 5 is a further exemplary modification of the illustrative examples of FIG. 3 and/or FIG. 5, wherein the air knife is configured to deliver heat to the spray flow emitted from the spray nozzle(s) prior to deposition on the substrate in accordance with the present disclosure;

FIG. 6 is a further exemplary modification of any of the arrangements disclosed herein, augmented with a radiant heater that delivers heat to the spray flow emitted from the spray nozzle(s) prior to deposition on the substrate in accordance with the present disclosure;

FIG. 7 is a further exemplary arrangement wherein both heated air knife and radiant heat are combined to control evaporation of solvent in a wet-spray operation in accordance with the present disclosure;

FIG. 8 is a further exemplary arrangement wherein the spray arrangement is augmented to include a vacuum having an inlet positioned below a non-continuous substrate that draws the spray flow to a deposition target area of the substrate in accordance with the present disclosure;

FIG. 9 is a further exemplary arrangement wherein the spray flow is emitted from the spray nozzle into a vacuum environment that aids directing the nanoparticle-laden spray flow to the substrate surface in accordance with the present disclosure;

FIG. 10 is a further exemplary arrangement wherein a high pressure environment is created wherein a higher-density bulk fluid can reduce the magnitude of this velocity in accordance with the present disclosure;

FIG. 11 is a further exemplary arrangement wherein an electrostatic spray nozzle is incorporated into any of the arrangements described herein in accordance with the present disclosure;

FIG. 12 is a further exemplary arrangement for in situ particle formation in combination with electrostatic spraying in accordance with the present disclosure;

FIG. 13 is an exemplary arrangement wherein an inductive/RF field source is added to enhance drying of particles in accordance with the present disclosure; and

FIG. 14 is a further exemplary arrangement wherein the arrangement of FIG. 13 is enhanced to include a camera configured to provide a thermal (e.g. infrared) image for ensuring proper heating field coverage in accordance with the present disclosure.

### DESCRIPTION OF EMBODIMENTS

Illustrative examples of nanoparticle spray systems are now described that address the need to provide satisfactorily precise and accurate coverage of substrates while minimizing waste of nanoparticle base material.

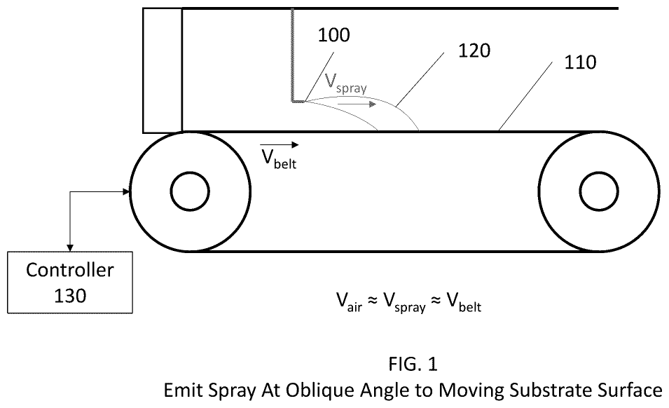

Referring to FIG. 1, an illustrative schematic block diagram is provided of a nanoparticle spray system arrangement wherein output spray 120 is emitted from a spray nozzle 100 at an oblique angle (with respect to a substrate surface 110). In an arrangement (not shown) where the nozzle aperture is oriented to emit a spray flow such that the principal velocity of emitted nanoparticles is directed substantially normal to the substrate surface 110, the resulting fluid flow creates a stagnation point at the surface. A relatively high-pressure volume is established proximate the substrate surface 110 that causes redirecting the spray flow 120 flow in directions parallel or even away from the substrate surface 110 rather than toward it. Thus, such arrangement tends to force particles away from the substrate surface 110 thereby potentially reducing the percentage of emitted nanoparticles that actually achieve deposition on the substrate surface 110.

With continued reference to FIG. 1, the spray nozzle 100 is physically configured to emit a nanoparticle spray 120 flow in a direction that is substantially oblique to, and more particularly substantially parallel to, a moving substrate surface 110 upon which a coating of nanoparticles is to be deposited. By emitting the spray 120 flow in a direction having a velocity component in a direction of a conveyed substrate surface, viscous dissipation will have an opportunity to cause any velocities to decay allowing particles to settle to the substrate surface 110 without a substantial flow field away from the surface. A controller 130 is provided to regulate a speed of a conveyer motor moving the conveyed substrate surface under the nanoparticle spray 120 flow.

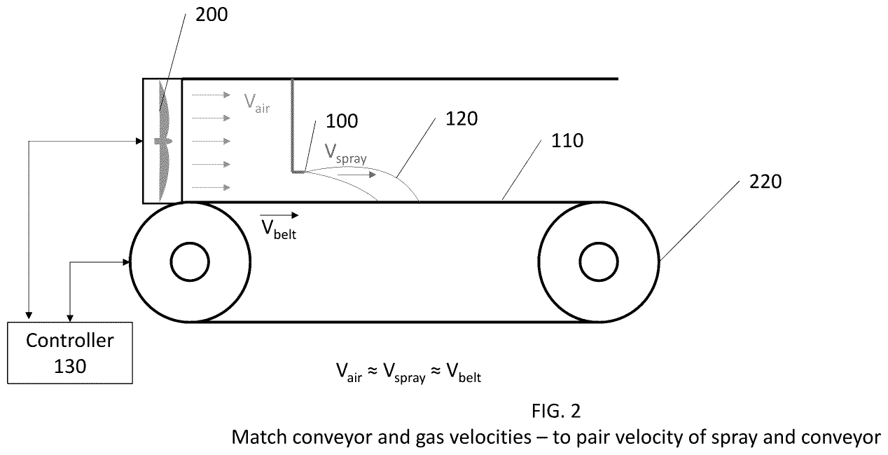

Turning to FIG. 2, the spray system is further configured to effectively match nanoparticle velocity and substrate surface velocity within a deposition region of the moving substrate surface 110. If there is a relative velocity between the substrate surface 110 and fluid of the output spray 120 adjacent to it, there will be a boundary layer in the fluid later at the interface between the two. The vorticity in this layer acts to push particles of the output spray 120 away from the substrate surface 110. For a moving substrate (such as a conveyor system), this effect can be minimized by matching or nearly matching the spray 120 flow velocity to the substrate surface 110 speed. Such velocity matching is achieved, at the boundary layer through the addition, to the arrangement depicted in FIG. 1, any one or more of the set of features of: a boundary layer stripping device, a shroud, and a fan(s).

The system depicted in FIG. 2 is further augmented with a combination of sensors and real-time feedback loop (under control of the controller 130) controlling any or both fan 200 speed and conveyor 220 speed so as to substantially match conveyor velocity (Vbelt) and gas/particle velocities of the spray 120 at the substrate surface 110. As such, the system may, in illustrative examples, include the controller 130 that processes velocity measurements and matches velocities of a controllable conveyor and spray flow. In a specific example, a Doppler sensor (not shown) is provided to sense particle velocity near the substrate surface. The range of acceptable velocity matching is determined through observation of resulting applied coating quality and thereafter ensuring proper matching of particle flow/substrate velocities by adjusting the belt speed (Vbelt) or blower air velocity (Vair)—by modifying the speed of the fan 200. The feedback-based control loop is operated in accordance with the determined particle flow/substrate velocity relationship for achieving desired coating qualities.

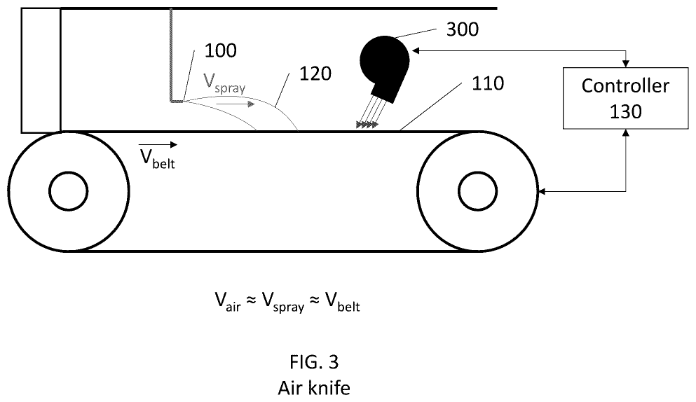

Turning to FIG. 3, in yet another implementation, an air knife 300 is added to any of the other implementations/arrangements disclosed herein. In particular, the air knife 300 is provided downstream of the spray nozzle 100. Absent inclusion of the air knife structure 300, the nanoparticles will tend to be distributed in space but may not necessarily be moving toward the substrate at a desired velocity. Adding a downstream flow direction device, in the form of the air knife 300, induces a flow velocity of the nanoparticle spray flow with a substantial component of velocity normal to the substrate creates streamlines that direct the nanoparticle spray flow 120 toward the substrate surface 110.

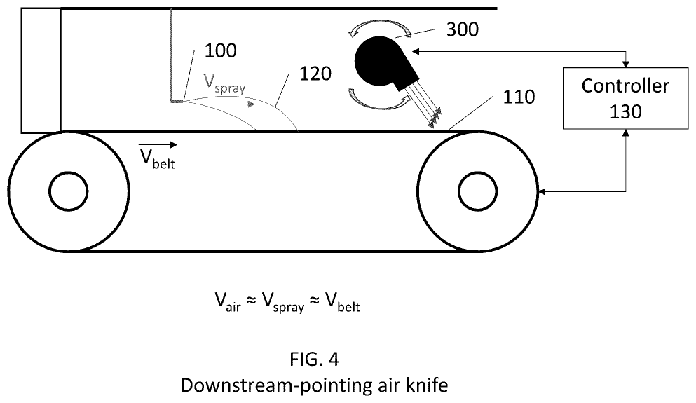

Turning to FIG. 4, the arrangement of FIG. 3 is particularly arranged such that the air knife 300 output has a flow velocity component parallel and in a direction of motion of the substrate surface 110 (also moving).

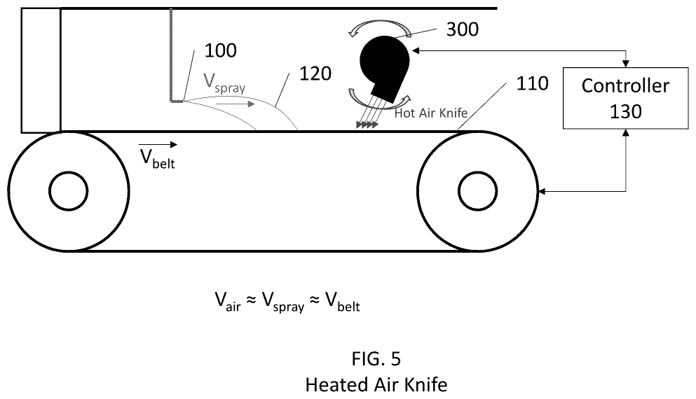

Turning to FIG. 5, the arrangement of FIG. 3 (or FIG. 4) is further configured to deliver heat, via the air knife 300, to the spray 120 flow emitted from the spray nozzle(s) 100 prior to deposition on the substrate surface 110.

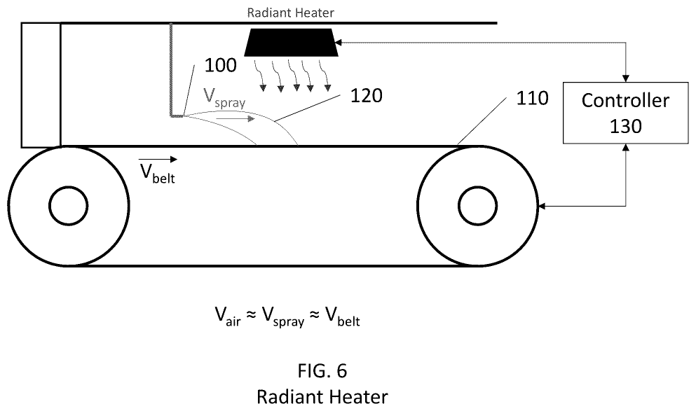

Turning to FIG. 6, any of the arrangements disclosed herein are augmented with a radiant heater 600 that delivers heat to the spray 120 flow emitted from the spray nozzle(s) 100 prior to deposition on the substrate surface 110.

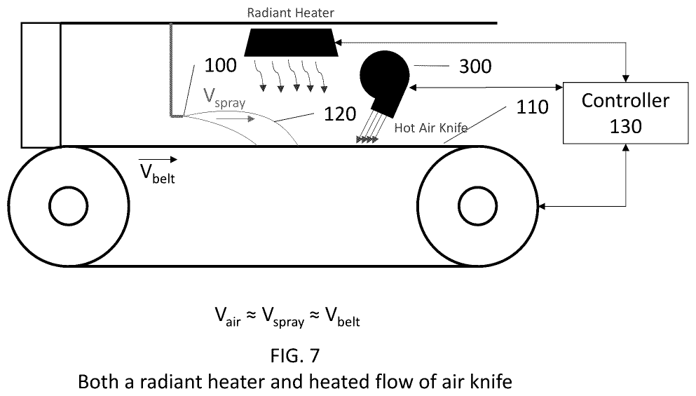

Turning to FIG. 7, combined heating via both the heated air knife 300 and radiant heat (via the radiant heater 600) is controllably used to control evaporation of solvent in a wet-spray operation. The radiant heater 600 helps to drive off a solvent in the spray 120 while the heated air flow from the heated air knife 300 also further driving the nanoparticles into the substrate. The combination of heating via the air knife 300 and additional heat from the radiant heater 600 will allow for enhanced speed of deposition. In a particular example, the two types of heat source of FIGS. 5 and 6 are combined to drive off (through evaporation) solvent in the spray flow while also using the air knife 300 to provide a heated air flow for further directing the remaining nanoparticles of the spray output 120 to the substrate surface 110. The combination the two heat sources enables controlled/enhanced speed of deposition. In a controlled/feedback-based arrangement, measurements of temperature, humidity, etc. are used to set heater operation to ensure efficacy of spray deposited on the substrate.

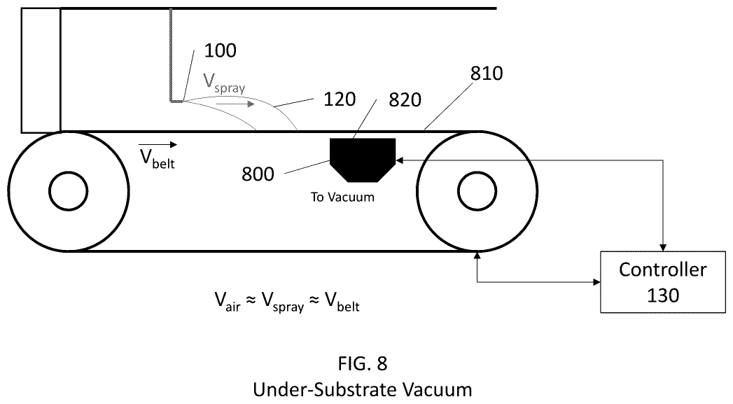

Turning to FIG. 8, the spray arrangement of FIG. 1 is augmented to include a vacuum 800 having an inlet positioned below a non-continuous substrate 810 that draws the spray 120 flow to a deposition target area of the substrate 810 drawn over an inlet 820 of the vacuum 800. If a substrate is not completely continuous (e.g. a woven fabric), the streamlines of the gas phase of the spray 120 flow can be drawn into (and through) the substrate 810 by application of negative-pressure by the vacuum 800 source having the inlet 820 positioned on a side of the substrate 810 opposite the substrate 810 surface to which spray 120 flow is directed. Such a flow will draw the particles through the fibers in a weave (e.g.) enhancing the deposition of the particles to such woven fabrics (or any non-continuous substrate surface).

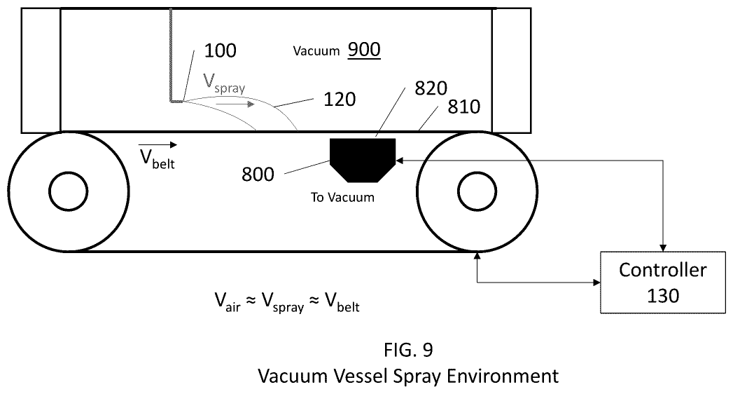

Turning to FIG. 9, the spray 120 flow is emitted from the spray nozzle 100 into a vacuum environment 900 that aids directing the nanoparticle-laden spray flow to the substrate surface 810. The streamlines of the gas phase of the spray 120 flow may hinder transfer of particles to the substrate 810. In such case, a solution is to reduce density of a gas phase through which the nanoparticle spray passes prior to deposition on the substrate 810 surface by creating a (partial) vacuum environment. This will also influence the distribution of the spray 120 by reducing (due to lower pressure environment) the vaporization point of the solvent, thereby increasing rate of evaporation of the solvent and improving the homogeneity of nanoparticle deposition on the substrate 810.

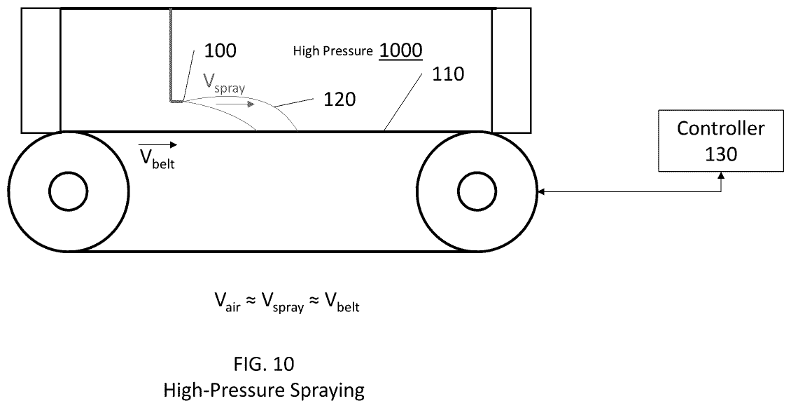

Turning to FIG. 10, in contrast to the reduction of environmental pressure, a high pressure environment 1000 is created wherein a higher-density bulk fluid can reduce the magnitude of this velocity. This can be achieved by spraying the spray 120 into a high-density bulk fluid in the high pressure environment 1000. The higher pressure reduces rate of evaporation of a solvent in a wet-spray application. Alternatively/additionally, evaporation may be slowed by reducing a temperature of a bulk fluid in the high pressure environment through which the emitted spray flow passes before deposition (e.g., lowering the temperature of the spray field above the substrate 110).

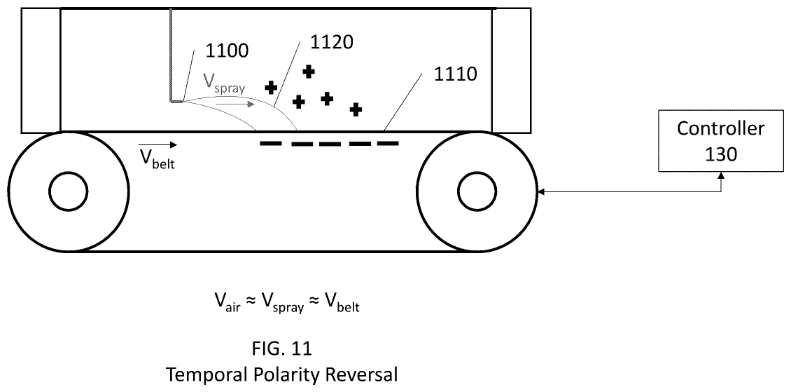

Turning to FIG. 11, an electrostatic spray nozzle 1100 is incorporated into any of the arrangements described herein. Electrostatic spraying, wherein an electric charge is induced upon particles of an output spray 1120 emitted from a nozzle of the electrostatic spray nozzle 1100 enhances distribution (spacing) of emitted spray particles. Moreover, the charged spray particles can be drawn to the substrate 1110 by applying an opposite electrical charge to the substrate 1110 surface.

Moreover, by not providing continuous electric charges, distribution of spray drops can be performed with enhanced control. In an exemplary arrangement, during injection, the spray and substrate will have the same charge while some part of the rest of the apparatus will hold the opposite charge. The charged particles in the spray will then initially move toward this oppositely-charged portion of the system. After start-of-injection, the charges of the system are modulated such that the substrate is brought to an opposite charge polarity of the nanoparticle-laden spray flow. The charged portion of the apparatus may also change polarity to repel particles of the spray flow. The spray 1120 particles that have spread in the flow field are thereafter drawn to the oppositely-charged substrate 1110.

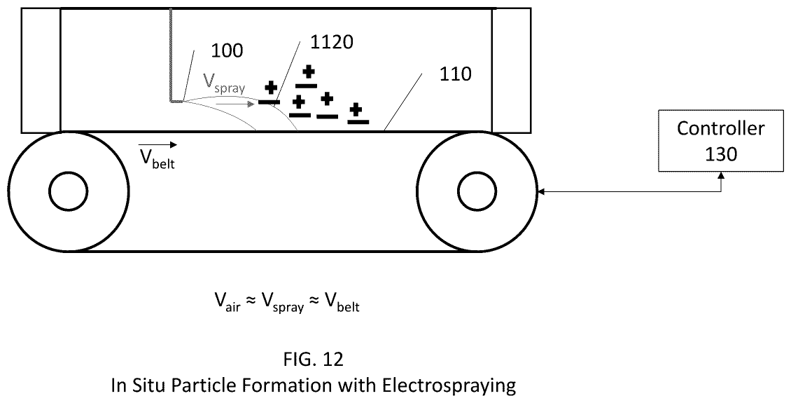

Turning to FIG. 12, an arrangement is depicted for in situ particle formation in combination with electrostatic spraying. In such arrangements, two sprays 1120 of opposite polarities are sprayed such that their flows overlap. Oppositely-charged particles will be drawn to one another at a particle level, thereby causing the very small oppositely-charged droplets to merge. The fluids of each spray are chosen such that they will react to create a solid particle potentially in a liquid suspension. Because the droplets where this reaction is happening are small, the particles will be small. This will allow for the creation of a large number of small particles without clumping, requiring spray drying or grinding, etc.

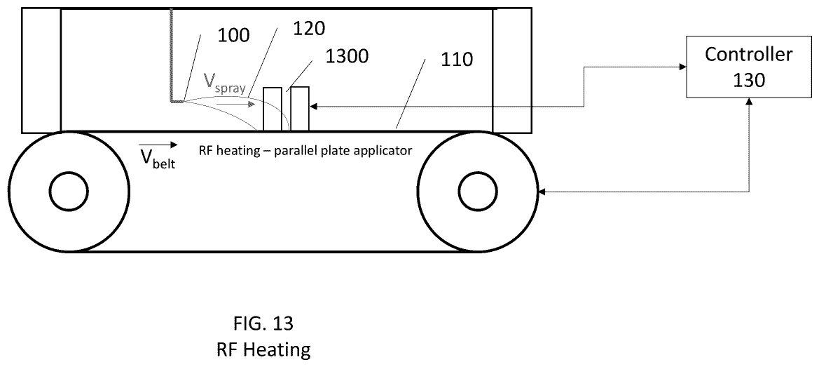

Turning to FIG. 13, an RF/electromagnetic field enhanced arrangement is depicted for heating sprayed material including a parallel plate RF heat source 1300.

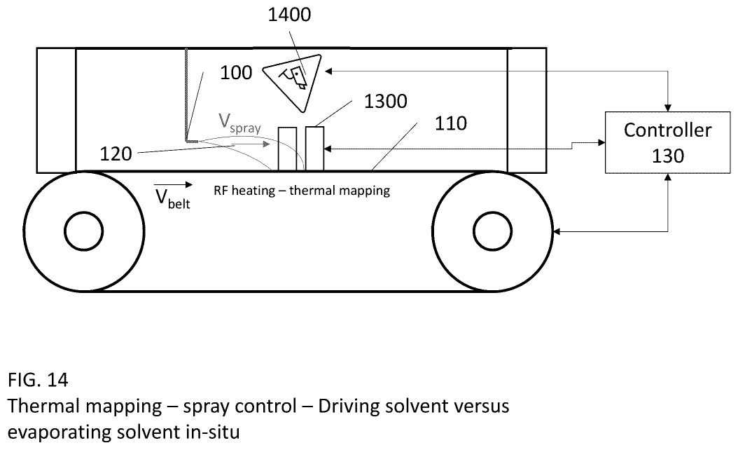

Turning to FIG. 14, is a further exemplary arrangement wherein the arrangement of FIG. 13 is enhanced to include a camera 1400 configured to provide a thermal (e.g. infrared) image for ensuring proper heating field coverage (provided by the RF heat source 1300) in accordance with the present disclosure.

Further enhancements/features of the arrangements disclosed herein include:
1. Sensing (after multiple passes) layer thickness through thermal mapping.
2. Implementing a graphite doping and drying/setting arrangement.
3. Incorporating a radio frequency-based heating arrangement.

Moreover, exemplary testing arrangement is contemplated where dye particles are used to configure/tune operation of a system prior to actual operation using substantially more expensive/costly nanoparticle material. Such system would enable building/prototyping a system prior to actual mass production. Testing/configuration/tuning may incorporate inductive feedback loops (e.g. radio frequency response) and use of machine learning and/or artificial intelligence to analyze results of testing and apply to further testing and/or configuration of actual operating systems.

It will be appreciated that the foregoing description relates to examples that illustrate a preferred configuration of the system. However, it is contemplated that other implementations of the invention may differ in detail from foregoing examples. As noted earlier, all references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A nanoparticle spray system comprising:
a spray nozzle configured to emit a nanoparticle-laden spray flow;
a conveyed substrate configured to be conveyed at a velocity; and
a controller configured to operate in a feedback loop such that nanoparticles of the nanoparticle-laden spray flow are controllably deposited on a surface of the conveyed substrate.

2. The nanoparticle spray system of claim 1, further comprising a fan providing a controllable air flow to the nanoparticle-laden spray flow under control of the controller.

3. The nanoparticle spray system of claim 1, further comprising an air knife providing a controllable air flow in a downward direction to the nanoparticle-laden spray flow under control of the controller.

4. The nanoparticle spray system of claim 3, wherein the air knife provides an airflow including at least a partial component in a direction parallel to flow of the conveyed substrate.

5. The nanoparticle spray system of claim 3, wherein the air knife provides a heated air flow.

6. The nanoparticle spray system of claim 1, further comprising a radiant heater providing a controllable heating energy to the nanoparticle-laden spray flow under control of the controller.

7. The nanoparticle spray system of claim 3, further comprising a radiant heater providing a controllable heating energy to the nanoparticle-laden spray flow in cooperation with providing the controllable air flow via the air knife under control of the controller.

8. The nanoparticle spray system of claim 1, further comprising a vacuum having an inlet positioned below a surface of the conveyed substrate, wherein the conveyed substrate comprises openings through which an air flow, including particles of the nanoparticle-laden spray flow, passes in a path towards the inlet of the vacuum in accordance with a controlled suction flow provided by the vacuum under control of the controller.

9. The nanoparticle spray system of claim 8, further comprising a vacuum vessel environment into which the nanoparticle-laden spray flow is provided by the spray nozzle.

10. The nanoparticle spray system of claim 1, further comprising a pressurized environment into which the nanoparticle-laden spray flow is provided by the spray nozzle.

11. The nanoparticle spray system of claim 1, wherein the spray nozzle is an electrostatic spray nozzle wherein a net charge is induced on the nanoparticle-laden spray flow under control of the controller.

12. The nanoparticle spray system of claim 11, wherein a polarity of an electrostatic field generated by an electrode of the electrostatic spray nozzle is unchanged during spray operation.

13. The nanoparticle spray system of claim 11, wherein a polarity of an electrostatic field generated by an electrode of the electrostatic spray nozzle is changed during spray operation.

14. The nanoparticle spray system of claim 11, wherein an opposite charge of the nanoparticle-laden spray flow is induced on the conveyed substrate during spray operation.

15. The nanoparticle spray system of claim 1, further comprising a radio-frequency induction heating element that operates under control of the controller to provide a controlled heating to the nanoparticle-laden spray flow.

16. The nanoparticle spray system of claim 15, further comprising a camera configured to capture an image of a heating field generated by the radio-frequency induction heating element, wherein the image is used by the controller to control operation of the radio-frequency induction heating element in accordance with a provided heating field target.

17. A method for applying a coating of nanoparticles, using a nanoparticle spray system, to a substrate comprising:
emitting, using a spray nozzle, a nanoparticle-laden spray flow;
conveying a conveyed substrate at a velocity; and
controlling the nanoparticle spray system, by a controller, to operate in a feedback loop such that nanoparticles of the nanoparticle-laden spray flow are controllably deposited on a surface of the conveyed substrate.
